(19) United States
(12) Patent Application Publication
(10) Pub. No.: US 2021/0312362 A1
(43) Pub. Date: Oct. 7, 2021

(54) PROVIDING ACTION ITEMS FOR AN ACTIVITY BASED ON SIMILAR PAST ACTIVITIES

(71) Applicant: Microsoft Technology Licensing, LLC, Redmond, WA (US)

(72) Inventors: Royi RONEN, Tel Aviv (IL); Abedelkader ASI, Kfar Bara (IL); Arshdeep SINGH, Hyderabad (IN); Sandeep N. MENON, Hyderabad (IN); Inbar OREN, Tel Aviv (IL)

(21) Appl. No.: 16/842,277

(22) Filed: Apr. 7, 2020

(51) Int. Cl. G06Q 10/06; G06F 16/28; G06N 20/20

(52) U.S. Cl. CPC G06Q 10/06313; G06N 20/20; G06F 16/285

(57) ABSTRACT

The disclosure herein describes providing action item information for a current activity based on similarity with past activities. Activity attributes indicative of an activity outcome are identified, and a random forest classifier based on the identified activity attributes is generated. The random forest classifier classifies an activity based on the activity attributes. Similarity factors associated with the current activity and past activities are calculated based on the random forest classifier. Based on the similarity factors, data value ranges of performance indicators of past activities associated with the activity outcome are determined. Based on comparing the determined data value ranges to performance indicator data values of the current activity, action item information associated with the performance indicator data values of the current activity is provided. The provided action item information enables users or entities associated with the current activity to take action to improve the likelihood of achieving the activity outcome.

### BACKGROUND

In the world of managing human interactions, multi-party opportunities, and other similar activities, comparison and analysis of successful activities is a challenging task due to the scope and complexity of the activities. Such activities may include large and varying quantities of attributes and, in many cases, on some of the attributes may be useful for analysis. Due to these issues, it is also a significant challenge to make use of knowledge of past successful activities to inform decision-making and behavior with respect to currently open activities.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for providing action item information for a current activity based on similarity with past activities is described. A set of activity attributes that are indicative of an activity outcome are identified in an activity data set and a random forest classifier based on the identified set of activity attributes is generated. The random forest classifier is configured to classify an activity based on the identified set of attributes. A set of similarity factors associated with the current activity is calculated based on the generated random forest classifier, wherein each similarity factor is associated with the current activity and a past activity associated with the activity outcome. Based on the set of similarity factors, at least one data value range of at least one performance indicator of past activities associated with the activity outcome is determined. Based on comparing the determined at least one data value range to at least one performance indicator data value of the current activity, action item information associated with the at least one performance indicator data value of the current activity is provided.

### BRIEF DESCRIPTION OF THE DRAWINGS

The present description will be better understood from the following detailed description read in light of the accompanying drawings, wherein:

FIG. 1 is a block diagram illustrating a system configured for providing action item information for an activity according to an embodiment;

FIG. 2 is a diagram illustrating a classifier tree configured for classifying an activity based on associated attributes according to an embodiment;

FIG. 3 is a diagram illustrating a random forest classifier configured for calculating a similarity factor between a current activity and a past activity according to an embodiment;

FIG. 4 is a block diagram illustrating a customer relationship management system configured for providing action item information for a customer relationship-based deal according to an embodiment;

FIG. 5 is a flow chart illustrating a computerized method of providing action item information for an activity based on past activities associated with an activity outcome according to an embodiment;

FIG. 6 is a flow chart illustrating a computerized method for providing action item information for a customer relationship-based deal based on past won deals according to an embodiment;

FIGS. 7A-E are diagrams illustrating graphical user interfaces (GUIs) configured to display action item information associated with a deal or other activity according to an embodiment; and

FIG. 8 illustrates a computing apparatus according to an embodiment as a functional block diagram.

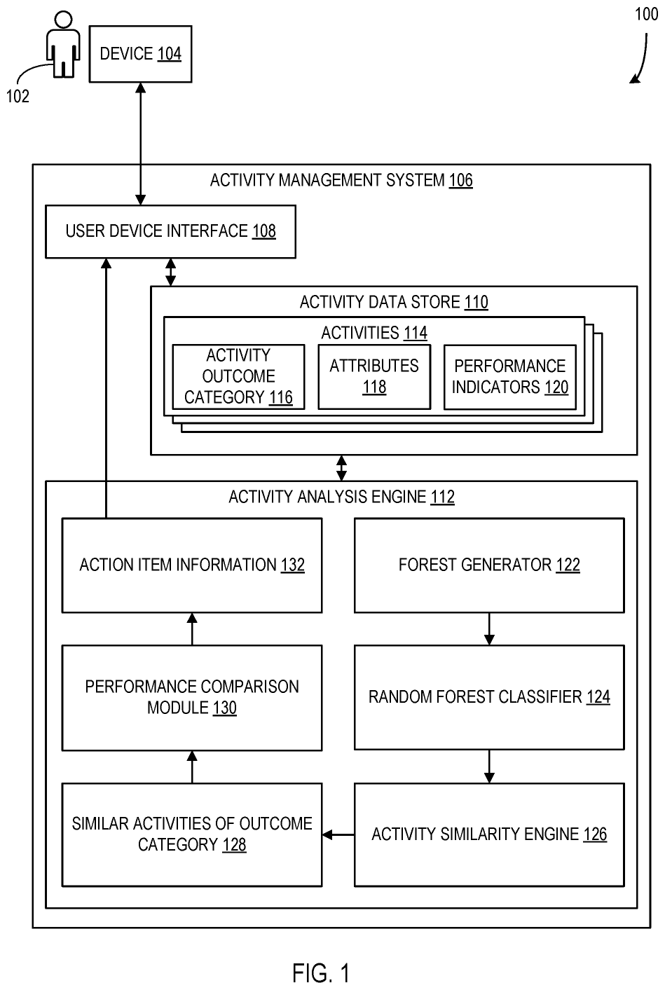

Corresponding reference characters indicate corresponding parts throughout the drawings. In FIGS. 1 to 8, the systems are illustrated as schematic drawings. The drawings may not be to scale.

### DETAILED DESCRIPTION

Using computer systems to manage human activities and interactions provides users with powerful tools for monitoring progress, recording metadata, scheduling meetings and reminders, and/or analyzing results. However, many activities include many different types of data that can be gathered, such as data associated with parties of the activity, timing aspects of the activity, location aspects of the activity, various categories of the activity, or the like, presenting users with very complex situations that are difficult to interpret or analyze. Further, because of the human aspect and decision making associated with an activity, the possible actions a user might take with respect to an activity are many and varied, further increasing the complexity of manually determining next steps that will lead to a successful result or other desired outcome.

The described method and system provide action item information for events, deals, or other activities that the user can use to inform decisions about next steps that are likely to enhance or improve outcomes of the activities using machine learning and associated classification techniques. Particularly, past activities that are similar to the current activity and that had a desirable outcome are identified using a trained classifier and performance indicators of the past activities are analyzed to determine the provided action item information for the current activity.

For instance, in an example, a user associated with a company is trying to close a current deal with a customer for sale of a service provided by the company. The user is using a management system to track data associated with the deal, including deal time information, communication and other interactions with the customer, and the like. Based on the data provided to the management system associated with the current deal, the management system identifies similar past deals by identifying deals that were successful and that were active for similar amounts of time, deals that included the same or similar customers, and/or deals that were for the same or similar sets of services. The management system then compares the performance indicators of the similar past deals to the performance indicators of the current deal to identify performance aspects of the current deal that are less than or otherwise different than those performance aspects of the similar past deals. For instance, the system may determine that the quantity of interactions by the user in the current deal is lower than the similar past deals by 20%. Based on the identified differences in performance, the system provides the user with action item information, such as a recommendation to increase the rate of communication with the customer.

Aspects of the disclosure provide a computerized method and system for providing action item information for a current activity based on similarity with past activities. The described method and system leverage random forest classification to enable similarity metric learning techniques that can be applied to current and past activities. Using these techniques, past activities that resulted in a desirable outcome and that are similar to a current activity can be identified and associated performance indicator metrics can be compared to provide action item information that is useful for making decisions about behavior for the current activity. The described process includes identifying a set of activity attributes that are indicative of the desired activity outcome and, based on those attributes, a random forest classifier is generated. The random forest classifier is configured to classify an activity based on the identified set of attributes. A set of similarity factors associated with the current activity is calculated based on the generated random forest classifier, wherein each similarity factor is associated with the current activity and a past activity associated with the activity outcome. Based on the set of similarity factors, data value ranges of performance indicators of past activities associated with the activity outcome are determined. Based on comparing the data value ranges to performance indicator data values of the current activity, action item information associated with the performance indicator data values are provided.

The disclosure addresses the challenges for customer relationship management system users and other entities associated with the activities described herein who make decisions and take actions to achieve success in such activities. The described methods and systems operate in an unconventional way by providing an efficient, accurate way to identify past activities or deals that are fundamentally similar to a current activity or deal based on attributes that are significantly indicative of a successful or otherwise desired activity outcome (e.g., deals that are won). Further, the provided action item information enables a user to make informed decisions about future actions or behavior that will enhance the likelihood that the current activity reaches the desired outcome. User interactions with the customer relationship management system or other similar management systems are improved by automating analysis of past activities or deals and providing clear, actionable information based on the analysis, such that users need to not spend time and effort trying to identify similar past activities or deals and doing manual analysis to identify useful patterns. Additionally, the described methods and systems may be deployed for use in entity-specific systems and the operations may be customized for use with the entity's data set (e.g., custom activities, attributes, performance indicators, etc.), providing for substantially enhanced efficiency and flexibility within the entity's management system.

FIG. 1 is a block diagram illustrating a system 100 configured for providing action item information 132 for an activity 114 according to an embodiment. The system 100 includes a user 102 with a computing device 104 that is connected to or otherwise in communication with an activity management system 106. The activity management system 106 includes a user device interface 108 configured for interacting with the user's device 104, an activity data store 110 configured to store data associated with activities 114, and an activity analysis engine 112 configured to analyze past activities to generate action item information for current activities as described herein.

The user device interface 108 includes hardware, firmware, and/or software configured to interact with the user 102's device 104 and/or other user devices to provide access to the activity management system 106. In some examples, the user device interface 108 is configured to establish connections with user devices or otherwise enable communication over a computer network (e.g., an intranet, the Internet, or other network). Such communications may be in the form of activity-based data, such as action item information 132, that is provided to the device 104, where it is displayed or otherwise provided to the user 102 via a user interface (e.g., a graphical user interface (GUI)). In further examples, the user device interface 108 includes a website or portal that is accessible by the device 104 via a browser application or an application that is specific to the activity management system 106.

The activity data store 110 includes hardware, firmware, and/or software configured to store data associated with activities 114 and enable other components of the system 100 to write data to the data store 110 and/or read data from the data store 110. The activity data store 110 may be configured to receive and store data of newly created activities, updated data for currently active activities, and/or changes to data associated with past activities. Further, the activity data store 110 may be configured to receive requests for activity data and, in response, provide the requested activity data to the source of the request. For instance, the user 102 may request current information about an active activity with which the user 102 is associated via the device 104 and the request for the information is provided to the activity data store 110. The activity data store 110 responds to the request by providing the requested information to the device 104 of the user 102 via the user device interface 108.

Activities 114 stored in the activity data store 110 are associated with activities, including currently occurring activities and/or past activities that have already occurred, of the user 102 and/or other users of the activity management system 106. In some examples, activities 114 include events involving one or more users, tasks involving one or more users, agreements, sales opportunities, or deals involving multiple users, or the like. For instance, an activity 114 may be an agreement or deal between user 102 and a customer with whom the user 102 is trying to complete the agreement or deal (e.g., the user 102 is attempting to convince the customer to sign a contract to purchase goods from the user 102's company for a defined amount of payment and/or over a defined period of time). While examples throughout the description may like an activity to such an agreement or deal in other examples, activities 114 may include events or other types of activities without departing from the description herein.

Activity data associated with the activities 114 and stored in the activity data store 110 include an activity outcome category 116 for each activity 114, attributes 118 of each activity, and/or performance indicators 120 of each activity. In some examples, activity outcome categories 116 include categories for activities that are still active or otherwise occurring and categories for past activities that have been completed or otherwise ended. Further, activity outcome categories 116 include categories indicating a positive or successful outcome of the activity and/or categories indicating a negative or unsuccessful outcome of the activity. Further, other types of outcome categories may also be use and associated to activities 114 without departing from the description herein. In some examples, where activities 114 include deals with customers, the activity outcome categories 116 include a won category indicating that the deal with the customer was successfully negotiated and/or the customer agreed to the deal and a lost category indicating that the deal with the customer was not successfully negotiated and/or the customer did not agree to the deal. In another example, an activity 114 is an event that has been held and the associated outcome categories 116 include a category for the event attracting a defined quantity of people and being considered a successful event and a category for the event attracting fewer than the defined quantity of people and being considered a failed event. Other types of activities and associated outcome categories may be used in the activity management system 106 without departing from the description herein.

Activities 114 include attributes 118 that are configured to define or describe the associated activity and/or specific aspects of the associated activity. For instance, data values of the attributes 118 may be stored in the activity data store 110 that describe or otherwise indicate details regarding time aspects of the activity (e.g., a start time of the activity, an end time of the activity, or a runtime of the activity), location aspects of the activity (e.g., where an event associated with the activity is being held), parties involved with the activity (e.g., a customer with whom a user is negotiating a deal or a point of contact within a company associated with the activity) and/or events that occur in association with the activity. Other types of attributes 118 may be stored in the activity data store 110 without departing from the description herein. Data associated with the attributes 118 of activities 114 may be in the form of numerical data values, categorical data values, or the like. In some examples, the activity data store 110 includes a data table with each activity 114 associated to at least one row of the data table. The attributes 118 of each activity 114 are represented as columns in the data table and each activity 114 may have a data value or values for attributes 118 stored in the data table at the intersection of the row associated with the activity 114 and the column associated with the particular attribute 118.

Performance indicators 120, like attributes 118, include data values and/or other types of data that are configured to define or describe what actions are performed, how actions are performed, and/or when actions are performed with respect to an associated activity. The performance indicators 120 of an activity 114 may be used by the activity analysis engine 112 to determine what action item information to provide to a user as described in greater detail below. Performance indicators 120, as described above with respect to attributes 118, may be stored in a data table of the activity data store 110 as columns in the table, such that each activity 114 row has an associated field for storing performance indicator data. Further, performance indicators 120 may be derived from other data points, such as attributes 118, associated with an activity (e.g., a performance indicator of rate of response to a customer may be derived from activity data describing when communications between the user and customer occur and which party initiates the communication, which may be stored as part of the attributes 118 of the activity 114). In some examples, the performance indicators 120 include key performance indicators (KPIs), which are data points that are associated with and/or indicative of a successful outcome of the activity. In an example, for an activity that is a deal being negotiated between a user and a customer, some performance indicators may include a quantity of customer interactions by the user, an hourly investment by the user, an average time to respond to customer communications, and a percentage of customer communications to which the user responds. In other examples, more, fewer, or different performance indicators may be used with an activity without departing from the description herein.

The activity analysis engine 112 includes hardware, firmware, and/or software configured to analyze past activity data and determine action items that a user may perform to increase the likelihood that a current activity with have a positive or otherwise desirable outcome. The activity analysis engine 112 is configured to interact with the activity data store 110 to retrieve data associated with activities 114 for use during the described analysis. The engine 112 includes a forest generator 122 that is configured to generate a random forest classifier 124. The random forest classifier 124 is used by the activity similarity engine 126 to identify similar activities of an outcome category 128. The performance comparison module is configured to compare the performance of the similar activities 128 to a current activity in order to determine action item information 132 to provide to the user 102 via the user device interface 108 in conjunction with the device 104.

The forest generator 122 includes hardware, firmware, and/or software configured to generate a random forest classifier 124 that includes a plurality of random classifier trees that are configured to classify activities based on attributes and associated outcome categories. In some examples, generating the random forest classifier 124 is based on the forest generator 122 identifying past activities that are associated with a positive or otherwise desired outcome category 116 (e.g., deals with customers that have been successfully negotiated, or “won”). The forest generator 122 is further configured to identify attributes 118 and/or data values, data value ranges, or data value thresholds of the identified attributes 118 that are indicative of the desired outcome category 116 and/or data values, data value ranges, and/or data value thresholds of the identified attributes 118 that are indicative of an outcome that is opposite of for different than the desired outcome category 116.

In some examples, an attribute 118 is indicative of an activity outcome category 116 when a defined quantity or percentage of activities with the attribute 118 of a value, value within a value range, or value on one side of a value threshold are associated with the activity outcome category 116. For instance, a quantity of advertisements attribute exceeding a threshold may be indicative of an associated event attracting enough people to have a successful outcome. In such a case, the forest generator 122 may identify that 75% of events in a successful outcome category exceeded the quantity of advertisements threshold, exceeding a required percentage threshold of 70%. Thus, the quantity of advertisements attribute with the associated threshold would be used in generating the random forest classifier 124 as an attribute 118 indicative of the desired outcome category 116. Other attributes and/or associated values, ranges, or thresholds may not be present in 70% or greater past activities that have the desired outcome category 116 such that those other attributes are not considered sufficiently indicative of the desired outcome category 116. In some examples, attributes 118 may be assigned weight factors or importance factors based on the degree to which they are indicative of a desired outcome (e.g., an attribute that is indicative of a desired outcome 90% of the time is assigned greater weight factor than an attribute that is indicative of a desired outcome 75% of the time).

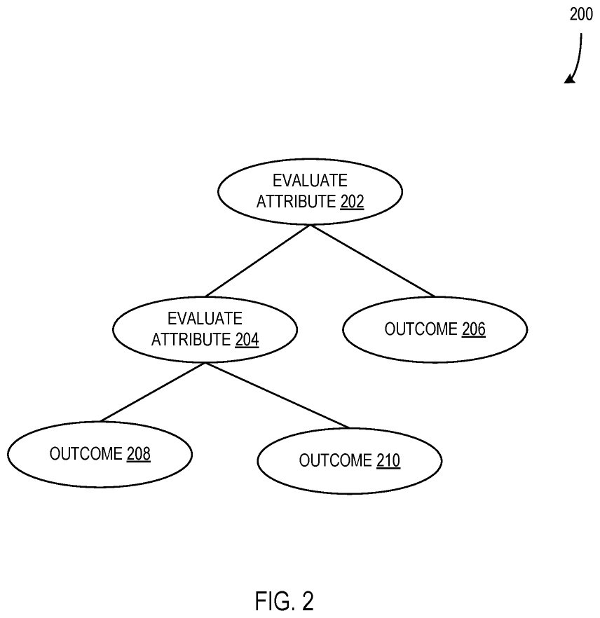

After identifying a subset of the attributes 118 that are indicative of the desired outcome category 116 based on the past activities 114, the forest generator 122 generates a plurality of classifier trees that are configured to evaluate some or all of the identified subset of indicative attributes 118 in a pattern or order, where the pattern or order for each classifier tree is randomly generated. As an example, FIG. 2 is a diagram illustrating a classifier tree 200 configured for classifying an activity based on associated attributes according to an embodiment. The classifier tree 200 includes two nodes that evaluate attributes 202 and 204 and three leaf nodes associated with outcomes 206, 208, and 210. In other examples, such a classifier tree may include more, fewer, or different nodes without departing from the description herein. The attribute evaluation nodes 202 and 204 are configured to each evaluate at least one of the indicative attributes that were previously identified and, based on the evaluation, classify the associated activity by assigning it to one of the node's child nodes (e.g., from node 202, an activity is assigned to either node 204 or node 206). If the assigned node is configured to evaluate another indicative attribute, that node does so and classifies the activity by assigning it to one of its child nodes. This process proceeds until the activity is assigned to a leaf node (e.g., a node in the tree without any children) which is associated with a particular outcome or outcome category 116. As illustrated, the tree 200 is configured to evaluate up to two indicative attributes at nodes 202 and 204 and, based on those evaluations, classify the associated activity in an outcome category at nodes 206, 208, or 210. While the outcome nodes 206, 208, and 210 are different nodes, in some examples, two or more of the outcome nodes may be associated with the same outcome category, such that the outcome nodes that share an outcome category may represent different sets of attributes and/or attribute values that result in the same outcome category classification.

Returning to FIG. 1, the forest generator 122 is configured to generate a plurality of classifier trees (e.g., classifier tree 200) that have random arrangements of attribute evaluation nodes, such that each classifier tree in the random forest classifier 124 may evaluate the indicative attributes of an activity in a different order or pattern. Further, the activity similarity engine 126 is configured to use the classifier trees of the random forest classifier 124 in conjunction to determine similarities between activities as described herein. In some examples, the activity similarity engine 126 is configured to classify a current activity using the random forest classifier 124 by providing attributes 118 of the current activity for evaluation by all of the classifier trees in the random forest classifier 124 and recording the leaf nodes of each classifier tree to which the current activity is assigned based on the evaluation. The activity similarity engine 126 further classifies a set of past activities associated with a desired outcome category using the random forest classifier 124 in the same manner. The results of the classification of the current activity are compared to the results of the classifications of the set of past activities and a similarity factor between the current activity and each of the past activities is calculated by determining the degree to which the classification results of the current activity match the classification results of each of the past activities.

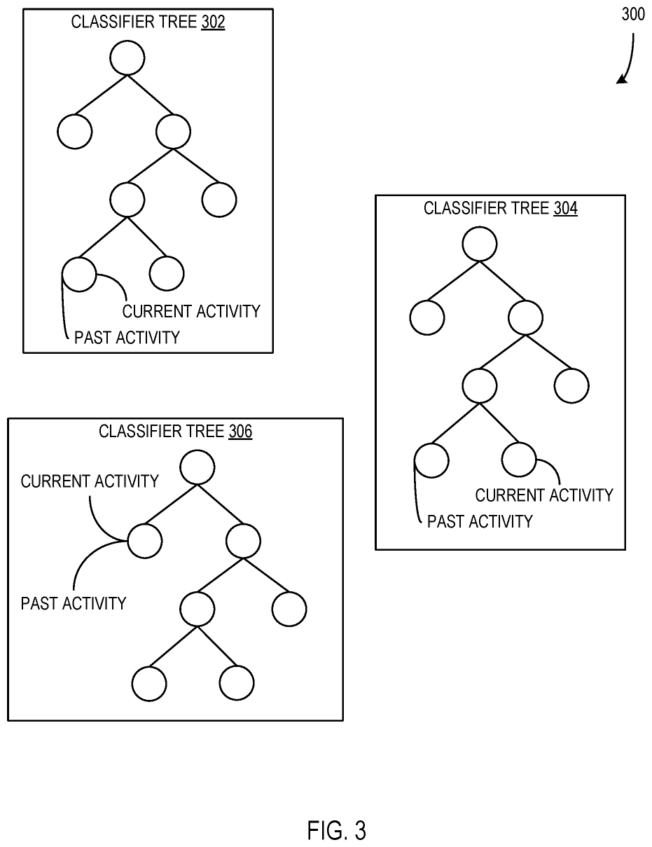

FIG. 3 is a diagram illustrating a random forest classifier 300 configured for calculating a similarity factor between a current activity and a past activity according to an embodiment. The random forest classifier 300 includes three classifier trees 302, 304, and 306. The leaf nodes to which a current activity and a past activity are assigned are indicated in each of the classifier trees. As illustrated, the current activity and past activity are assigned the same leaf node in classifier trees 302 and 306, while they are assigned to different leaf nodes in classifier tree 304. In such an example, the similarity factor for the current activity and past activity may be calculated as 66.67% (2 matching leaf nodes/3 trees).

In other examples, similarity factors may be calculated based on the percentage of matching nodes assigned to the activities and/or shared paths throughout the classifier trees of the random forest classifier. As illustrated, the current and past activity share 100% of nodes in the classifier tree 302, 100% of nodes in classifier tree 306, and 75% of nodes in classifier tree 304. Thus, the similarity factor for the current activity and the past activity may be calculated as 91.67% ((100%+100%+75%)/3 trees).

In other examples, more, fewer, or different classifier trees may be generated and included in the random forest classifier without departing from the description herein.

Returning to FIG. 1, the activity similarity engine 126 is configured to identify a set of similar activities of an outcome category 128 by calculating similarity factors between the current activity and past activities as described above. The similar activities 128 may be identified by selecting all the activities of the desired outcome category that are associated with a similarity factor that exceeds a defined similarity threshold (e.g., the similar activities may be all activities with similarity factors that exceed 60%).

The performance comparison module 130 includes hardware, firmware, and/or software configured to analyze performance indicators 120 of the similar activities 128 to determine action item information 132 to be provided to the user 102. In some examples, the performance comparison module 130 is configured to analyze the performance indicators 120 of the similar activities 128 by identifying performance indicator patterns and/or ranges that are shared by some or all of the similar activities 128. Such patterns or ranges may include average values of performance indicators (e.g., the similar activities 128 have an average number of communications per week of 3.5) and/or average value ranges of performance indicators (e.g., the similar activities 128 have hours spent in a range of 30 to 45 hours).

Based on the identified performance indicator patterns and/or ranges, the performance comparison module 130 is configured to compare the performance indicator data values of the current activity and identify performance indicators where the current activity differs from or is outside the range of the identified performance indicator patterns and/or ranges. The performance comparison module 130 may identify one or more of these differing performance indicators of the current activity. Further, the module 130 may be configured to prioritize performance indicator values that differ more from the patterns and/or ranges of the similar activities over performance indicator values that differ less (e.g., a performance indicator value of the current activity that is 50% less than the pattern of the past activities is prioritized over a performance indicator value that is 10% less than the pattern of the past activities).

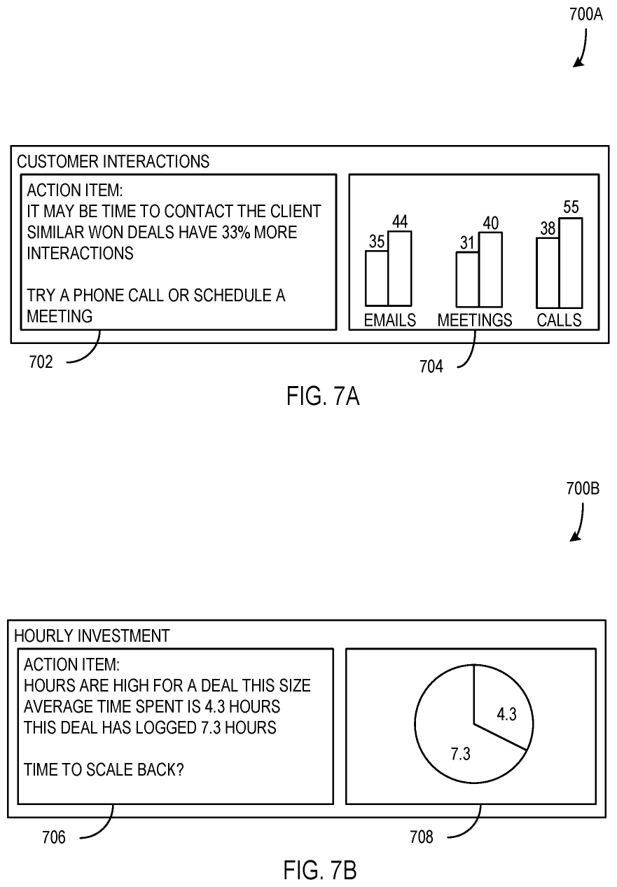

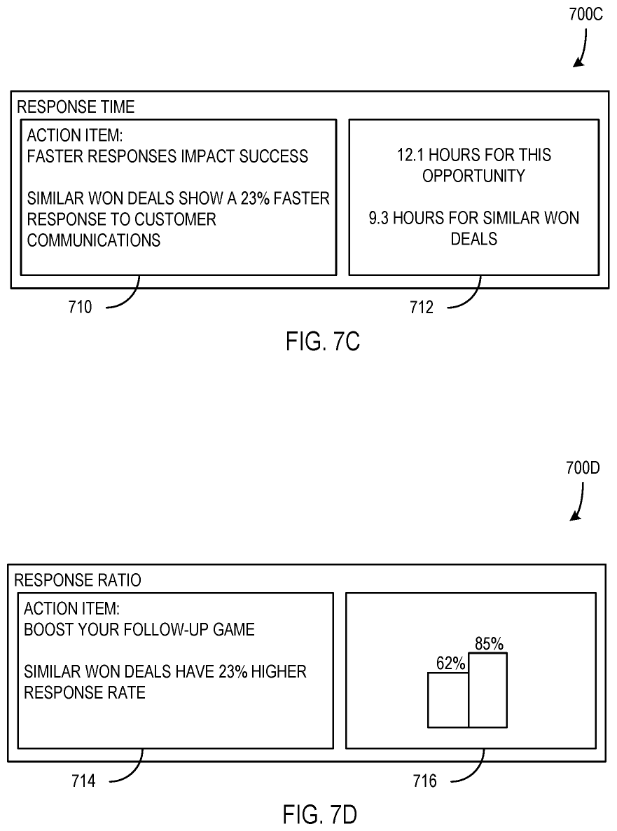

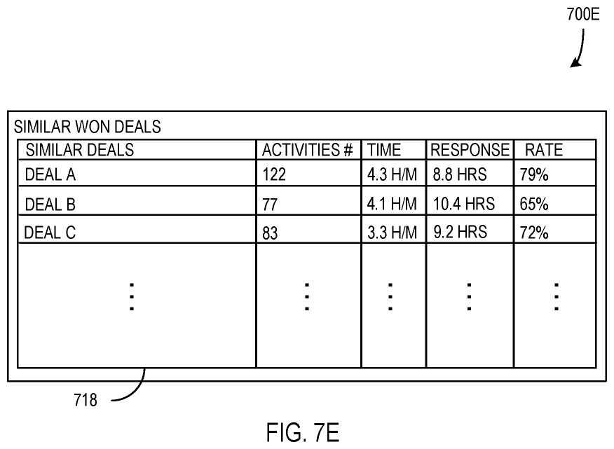

Further, the performance comparison module 130 is configured to use the identified differing performance indicator values of the current activity to generate action item information 132. In some examples, the module 130 generates action item information 132 that includes comparison information between the performance indicators of the current activity and the performance indicator patterns and/or ranges of the similar past activities 128. Such comparison information may include text and/or visual representations (e.g., graphs, charts, or other visualizations) of the differences between the current activity and the similar past activities 128. Additionally, or alternatively, the performance comparison module 130 may generate action item information that includes natural language phrases and/or prompts associated with the identified differing performance indicator values. For instance, text that recommends that the user take an action to improve the associated performance indicator may be generated and provided to the user. Examples of the action item information provided to and/or displayed to a user are provided and described below with respect to FIGS. 7A-7E.

In some examples, action item information 132 may be generated by selecting defined action item information from a data store, wherein the action item information the data store is mapped to or otherwise associated with individual performance indicators 120 of the activities 114. Alternatively, or additionally, the action item information 132 may be generated dynamically via natural language generation based on the associated different performance indicators.

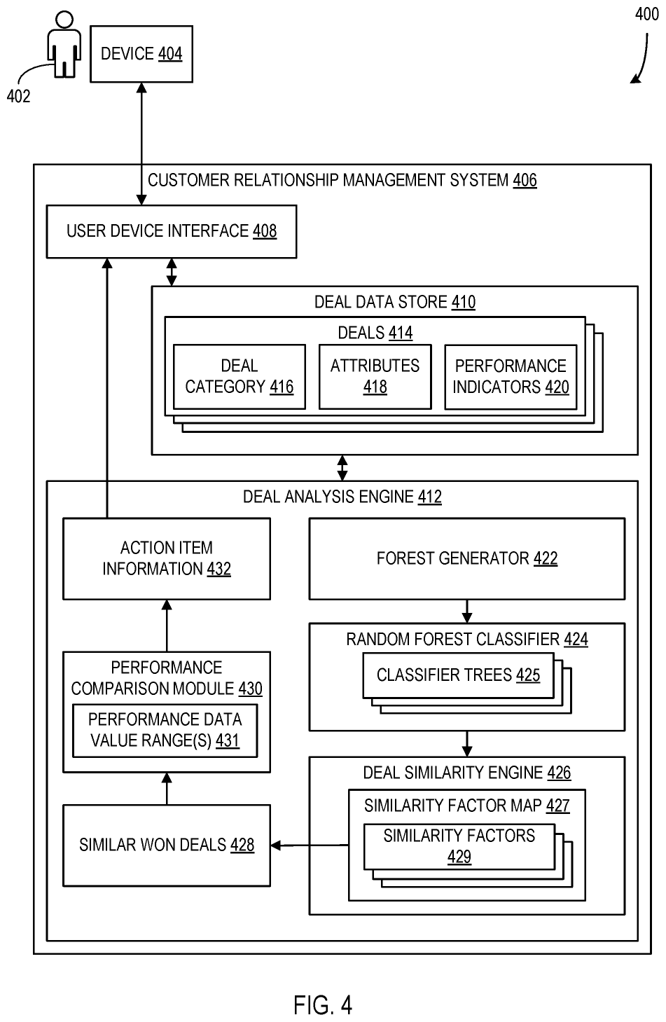

FIG. 4 is a block diagram illustrating a customer relationship management system 406 configured for providing action item information 432 for a customer relationship-based deal 414 according to an embodiment. In some examples, the customer relationship management system 406 is configured to operate in substantially the same manner as the management system 106 of FIG. 1 with specific focus on the management of customer relationships and agreements, sales opportunities, or “deals” associated therewith. The user 402 uses a computing device 404 to access and interact with the customer relationship management system 406 via the user device interface 408.

The deal data store 410 stores deals 414 and the associated deal data, including deal categories 416, deal attributes 418, and deal performance indicators 420. In some examples, deals 414 are associated agreements, contracts, and/or transactions between the user 402 or an entity with which the user 402 is associated and a customer. Deals 414 may be associated with an active or open deal category 416 indicating that negotiations for the deal are currently ongoing and/or that the deal has not been completed or finalized. Further, deals 414 may be associated with a won category indicating that the deal has been completed successfully and/or that the customer has agreed to enter into a contract, transaction, or other relationship associated with the deal, or a lost category indicating that the deal has been closed unsuccessfully and/or that the customer has not agreed to enter into a contract, transaction, or other relationship associated with the deal.

In some examples, attributes 418 of the deals 414 include party identities (e.g., the user's identity and/or the customer's identity), deal size (e.g., the total cost or transaction amount of the deal), deal age (e.g., time since the deal was first initiated), deal start date, and/or deal type or category (e.g., the type of goods or services associated with the deal). Further, attributes 414 may include more, fewer, or different deal attributes without departing from the description herein.

Additionally, the performance indicators 420 of deals 414 may include customer interaction quantity, hourly investment, time taken to respond to customer communications, and/or percentage of customer communications that have received a response. In other examples, more, fewer, or different deal performance indicators may be included without departing from the description herein.

In some examples, the deal analysis engine 412 is configured to operate in substantially the same manner as the activity analysis engine 112 of FIG. 1 while focusing on analysis of deals 414. The forest generator 422 generates a random forest classifier 424 that is populated with a plurality of classifier trees 425. The classifier trees 425 are generated based on a target or desired deal category 416 (e.g., deals 414 associated with the won category 416) and attributes 418 that are indicative of that desired deal category 416 as described herein.

The deal similarity engine 426 is configured to use the random forest classifier 424 to calculate similarity factors 429 between a current deal and past deals 414 associated with a won deal category 416, or “won deals”. The similarity factors 429 are stored in a similarity factor map 427, which includes, for each current deal-won deal combination, an associated similarity factor 429, such that a current deal-won deal combination is mapped to a similarity factor 429. The similarity factor map 427 is used by the deal similarity engine 426 to identify a subset of similar won deals 428 based on the similarity factors 429. As described above, the similar won deals 428 may be identified based on associated similarity factors 429 exceeding a defined similarity threshold. Alternatively, or additionally, a defined quantity or percentage of won deals with the highest similarity factors 429 may be selected as similar won deals 428.

The performance comparison module 430 is configured to identify performance data value ranges 431 based on the performance indicators 420 of the similar won deals 428. The performance data value ranges 431 may include data ranges of one or more performance indicators 420 (e.g., the similar won deals 428 have time spent per million dollars of deal size of 5 to 8 hours). Additionally, or alternatively, such data value ranges 431 may include specific data values (e.g., the similar won deals 428 have 100% response rates to customer communications) and/or data value thresholds (e.g., the similar won deals 428 have response times to customer communications of 3 hours or less) associated with the performance indicators 420 of the similar won deals 428. Further, the performance comparison module 430 is configured to generate action item information 432 based on comparison of the performance indicators 420 of a current deal with the performance data value ranges 431, as described above with respect to the performance comparison module 130 of FIG. 1. Examples of action item information 432 are provided below in the description associated with FIGS. 7A-7E.

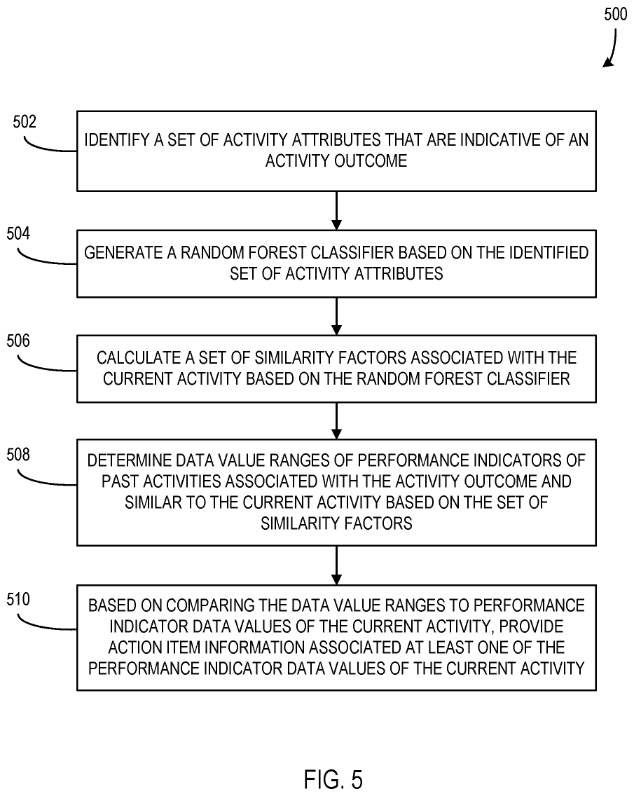

FIG. 5 is a flow chart illustrating a computerized method 500 of providing action item information (e.g., action item information 132) for an activity (e.g. an activity 114) based on past activities associated with an activity outcome (e.g., an activity outcome category 116) according to an embodiment. In some examples, the computerized method 500 is performed or otherwise executed by a system such as system 100 of FIG. 1 and/or a component or components thereof, such as the activity management system 106 of FIG. 1. At 502, a set of activity attributes that are indicative of an activity outcome are identified. The activity attributes may be identified from a data store, such as an activity data store 110. Identifying the activity attributes that are indicative of an activity outcome may include identifying a threshold value of an attribute such that a defined ratio or percentage of the past activities associated with the activity outcome have values associated with the attribute on one side of the threshold value. Further, another defined ratio or percentage of past activities associated with an opposite activity outcome (e.g., a successful outcome vs an unsuccessful outcome) have values associated with the attribute on the other side of the threshold value.

Such a threshold value may be selected to optimize or prioritize the most complete or accurate division between past activities of the two different outcomes or otherwise between past activities associated with a defined outcome and past activities associated with outcomes other than the defined outcome, such that the greatest number of past activities associated with the defined outcome are on one side of the threshold value and the greatest number of past activities associated with the opposite outcome or otherwise not associated with the defined outcome are on the other side of the threshold value. In this way, the selected threshold value provides an effective tool for classifying activities by outcome based on the attribute.

At 504, a random forest classifier (e.g., the random forest classifier 124) is generated based on the identified set of activity attributes. In some examples, generating the random forest classifier includes generating a plurality of classifier trees (e.g., classifier tree 200). Each classifier tree is generated to include a plurality of nodes associated with some or all of the identified set of activity attributes and those nodes are arranged in a random order or arrangement within each classifier tree as described herein.

At 506, a set of similarity factors associated with the current activity are calculated based on the random forest classifier. In some examples, calculating the set of similarity factors includes calculating a similarity factor associating the current activity with each past activity associated with the activity outcome, such that each combination of the current activity and past activity are mapped to an associated similarity factor. Further, calculating a similarity factor may be based on a percentage of classifier trees of the random forest classifier that classify the current activity and the past activity on a matching leaf node as described herein.

At 508, data value ranges of performance indicators of past activity associated with the activity outcome are determined. The data value ranges are based on past activities that are similar to the current activity, which may be based on the calculated similarity factors. In some examples, the past activities similar to the current activity are identified based on comparing the associated similarity factors to a defined similarity threshold and the performance indicator data values of the identified similar activities are used to determine the data value ranges.

At 510, the data value ranges are compared to performance indicator data values of the current activity, and based on the comparison, action item information associated with at least one of the performance indicator data values of the current activity is provided. In some examples, the comparison includes identifying performance indicator data values of the current activity that are outside of the data value ranges. Further, performance indicator data values that are substantially outside of the data value ranges may be prioritized for addressing with action item information. The action item information provided may include text information and/or visualization information that provides a user with comparison information between the current activity and similar past activities and/or prompts describing recommended actions for the user to take.

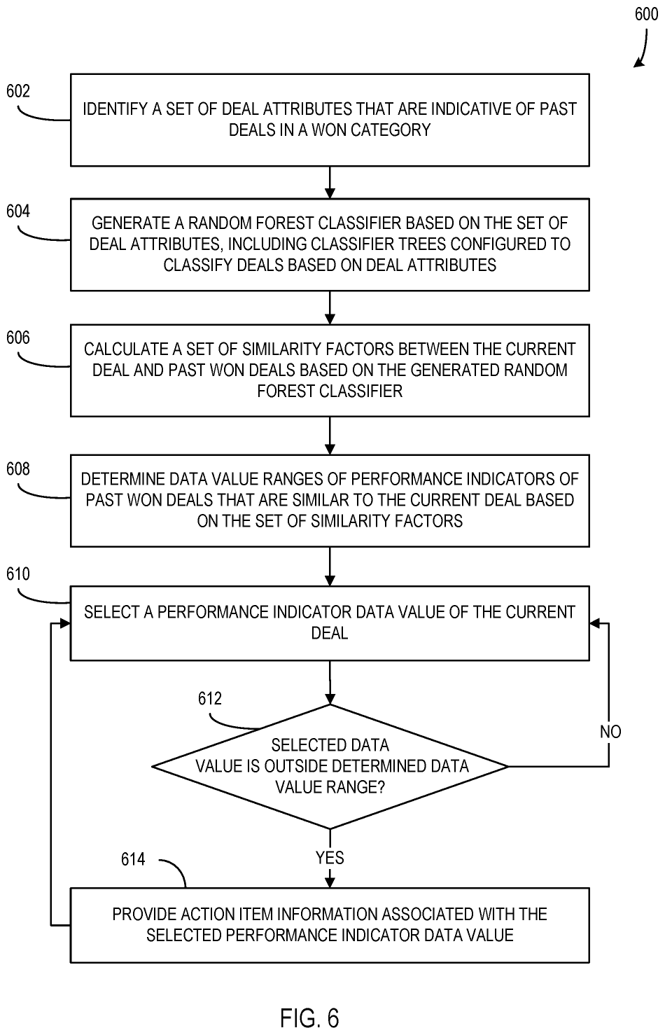

FIG. 6 is a flow chart illustrating a computerized method 600 for providing action item information (e.g., action item information 432) for a customer relationship-based deal (e.g., a deal 414) based on past won deals according to an embodiment. In some examples, the computerized method 600 is performed or otherwise executed by a system such as system 400 of FIG. 4 and/or a component or components thereof, such as the customer relationship management system 406 of FIG. 4. At 602, a set of deal attributes that are indicative of past deals in a won category (“won deals”) are identified. In some examples, identifying the set of deal attributes indicative of won deals includes identifying a threshold value for each attribute. The threshold value is selected such that a defined ratio or percentage of won deals have data values associated with the attribute on one side of the threshold value and such that a defined ratio or percentage of past deals in the lost category or past deals that are otherwise not in the won category have data values associated with the attribute on the other side of the threshold value. Further, the set of deal attributes may include at least one of an age of the deal attribute, a size of the deal attribute, a location associated with the deal attribute, a deal opening date attribute, a deal closing date attribute, a deal type or category attribute, an owner of the deal attribute, and/or a customer of the deal attribute.

At 604, a random forest classifier is generated based on the identified set of deal attributes. The random forest classifier includes classifier trees that are configured to classify deals based on at least a portion of the identified set of deal attributes. In some examples, the classifier trees are generated to include a plurality of nodes that are configured to evaluate the identified set of deal attributes and, in each classifier tree, the plurality of nodes are arranged in a random order or pattern within the classifier tree.

At 606, a set of similarity factors between the current deal and past won deals are calculated based on the generated random forest classifier. In some examples, calculating the set of similarity factors includes calculating each similarity factor between a current deal and a won deal based on a percentage of classifier trees of the random forest classifier that classify the current deal and the won deal on a matching leaf node. Alternatively, or additionally, calculation of a similarity factor may be based on a percentage of matching nodes and/or paths during classification of the current deal and the won deal, as described herein.

At 608, data value ranges of performance indicators of past won deals that are similar to the current deal are determined based on the calculated set of similarity factors. Further, in some examples, a set of similar won deals is identified based on the calculated similarity factors by determining the won deals with similarity factors that exceed a similarity threshold. Those identified similar won deals are then used as the set of deals from which the data value ranges of performance indicators are determined. Alternatively, or additionally, the set of similar won deals may be based on determining a percentage or quantity of won deals that have the highest or greatest similarity factors with respect to the current deal. Additionally, or alternatively, the performance indicators for which the data value ranges are determined may include at least one of a customer interaction quantity, a customer interaction type, a quantity of time spent, a response rate to customer communications, and/or a time to respond to customer communications.

At 610, a performance indicator data value of the current deal is selected and, at 612, if the selected data value is outside of an associated determined data value range, the process proceeds to 614. Alternatively, if the selected data value is not outside of the determined data value range, the process returns to 610 to select another performance indicator data value of the current deal. Selecting a performance indicator data value may include selecting one performance indicator from the set of performance indicators for which the data value ranges have been determined and the selected data value is then compared to the data value range of the associated performance indicator. In some examples, in addition to determining which data values of the current deal are outside of the associated data value range, selecting data values for which action item information is to be provided includes prioritizing the data values which differ significantly from the associated data value range over data values which differ less significantly from the associated data value range.

At 614, action item information associated with the selected performance indicator data value is provided. In some examples, the action item information is provided for display on a user's device (e.g., device 404) and it may include text information and/or visualizations that provide comparisons between the current deal and similar won deals and/or prompts regarding actions to be taken as described herein.

### Additional Example Scenarios

Aspects of the disclosure enable various additional scenarios, such as next described.

FIGS. 7A-E are diagrams illustrating graphical user interfaces (GUIs) 700A-E configured to display action item information associated with a deal or other activity according to an embodiment. In some examples, the GUIs 700A-E are displayed to a user (e.g., users 102, 402) on an interface of a device (e.g., devices 104, 404) as a result of action item information provided by a management system (e.g., management systems 106, 406) as described herein.

FIG. 7A shows a customer interactions GUI 700A. The customer interactions GUI 700A includes an action item section 702 that provides text action item information which includes comparison information between the current deal and similar won deals and a prompt for action that the user may take to improve the chances of winning the current deal (“Try a phone call or schedule a meeting”). The GUI 700A also includes a visualization section 704 that shows bar graphs to illustrate comparisons between the current deal and similar won deals for three types of customer interactions: emails, meetings, and phone calls.

FIG. 7B shows an hourly investment GUI 700B. The hourly investment GUI 700B includes an action item section 706 that provides text action item information which includes comparison information between the current deal and similar won deals and a prompt for action that the user may take to improve the cost efficiency or the current deal (“Time to scale back?”). Further, the GUI 700B includes a visualization section 708 that shows a pie graph to illustrate a comparison of the hours spent between similar won deals and the current deal.

FIG. 7C shows a response time GUI 700C. The response time GUI 700C includes an action item section 710 that provides text action item information which includes comparison information between the current deal and similar won deals and a prompt for a behavioral change the user may take to improve the chances of winning the current deal (“Faster responses impact success”). The GUI 700C further includes a comparison section 712 that provides information that directly compares the response time data between the current deal and similar won deals.

FIG. 7D shows a response ratio GUI 700D. The response ratio GUI 700D includes an action item section 714 that provides text action item information which includes comparison information between the current deal and similar won deals and a prompt for a behavioral change the user may take to improve the chances of winning the current deal (“Boost your follow-up game”). The GUI 700D further includes a visualization section 716 that provides information that directly compares the response ratio data between the current deal (62%) and similar won deals (85%).

FIG. 7E shows a similar won deals GUI 700E. The similar won deals GUI 700E includes a data table of won deals that are similar to the current deal. The table includes rows for Deal A, Deal B, and Deal C, which include associated attributes and/or performance indicators of the respective deals. The displayed deal data includes an activity count for the deal (“Activities #”) which represents the number of interactions with the customer or other related activities for the deal. A time data point is included which provides a data value for hours spent on the deal per million-dollar value of the deal. A response data point is included which provides a total number of hours taken to respond to customer communications, and a rate data point is included which provides a percentage of customer communications that were responded to. It should be understood that, in other examples, the similar won deals GUI 700E may include more, fewer, or different deals as well as more, fewer, or different data points, attributes, and/or performance indicators without departing from the description herein.

### Exemplary Operating Environment

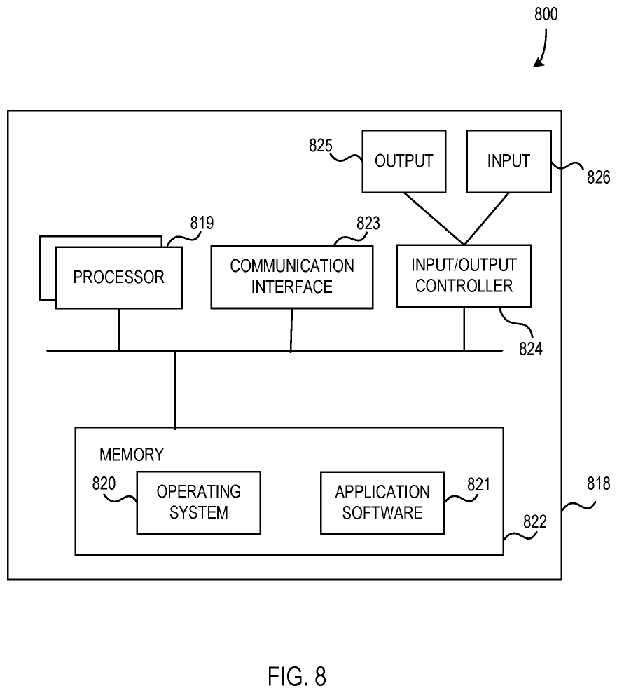

The present disclosure is operable with a computing apparatus according to an embodiment as a functional block diagram 800 in FIG. 8. In an embodiment, components of a computing apparatus 818 may be implemented as a part of an electronic device according to one or more embodiments described in this specification. The computing apparatus 818 comprises one or more processors 819 which may be microprocessors, controllers or any other suitable type of processors for processing computer executable instructions to control the operation of the electronic device. Alternatively, or in addition, the processor 819 is any technology capable of executing logic or instructions, such as a hardcoded machine. Platform software comprising an operating system 820 or any other suitable platform software may be provided on the apparatus 818 to enable application software 821 to be executed on the device. According to an embodiment, analyzing past activities associated with desired outcomes and providing action item information for current activities based thereon as described herein may be accomplished by software, hardware, and/or firmware.

Computer executable instructions may be provided using any computer-readable media that are accessible by the computing apparatus 818. Computer-readable media may include, for example, computer storage media such as a memory 822 and communications media. Computer storage media, such as a memory 822, include volatile and non-volatile, removable and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 822) is shown within the computing apparatus 818, it will be appreciated by a person skilled in the art, that the storage may be distributed or located remotely and accessed via a network or other communication link (e.g. using a communication interface 823).

The computing apparatus 818 may comprise an input/output controller 824 configured to output information to one or more output devices 825, for example a display or a speaker, which may be separate from or integral to the electronic device. The input/output controller 824 may also be configured to receive and process an input from one or more input devices 826, for example, a keyboard, a microphone or a touchpad. In one embodiment, the output device 825 may also act as the input device. An example of such a device may be a touch sensitive display. The input/output controller 824 may also output data to devices other than the output device, e.g. a locally connected printing device. In some embodiments, a user may provide input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for providing action item information for a current activity based on similarity with past activities comprises: at least one processor of a management system; and at least one memory of the management system comprising computer program code, the at least one memory and the computer program code configured to, with the at least one processor, cause the at least one processor to: identify a set of attributes in an activity data set that are indicative of an activity outcome; generate a random forest classifier based on the identified set of attributes, wherein the random forest classifier is configured to classify an activity based on the identified set of attributes; calculate a set of similarity factors associated with the current activity based on the generated random forest classifier, wherein each similarity factor of the set of similarity factors is associated with the current activity and a past activity associated with the activity outcome in the activity data set; determine at least one data value range of at least one performance indicator of past activities associated with the activity outcome and similar to the current activity based on the set of similarity factors; and based on comparing the determined at least one data value range to at least one performance indicator data value of the current activity, provide action item information associated with the at least one performance indicator data value of the current activity.

An example computerized method for providing action item information for a current deal based on similarity with past deals in a customer relationship management system comprises: identifying, by a processor, a set of deal attributes in a deal data set that are indicative of past deals in a won category, wherein the deal data set includes deal data associated with past deals in the won category and past deals in a lost category; generating, by the processor, a random forest classifier based on the identified set of deal attributes and deal data of the past deals in the won category, wherein the random forest classifier includes a set of classifier trees configured to classify a deal based on at least a subset of deal attributes of the identified set of deal attributes; calculating, by the processor, a set of similarity factors based on the generated random forest classifier, wherein each similarity factor of the set of similarity factors indicates similarity between a deal in the won category of the deal data set and the current deal based on classifications of the set of classifier trees; determining, by the processor, at least one data value range of at least one performance indicator of past deals in the won category that are similar to the current deal based on the calculated set of similarity factors; and based on comparing the determined at least one data value range to at least one performance indicator data value of the current deal, providing, by the processor, action item information associated with the at least one performance indicator data value of the current deal.

One or more computer storage media having computer-executable instructions for providing action item information for a current deal based on similarity with past deals in a customer relationship management system, upon execution by a processor, cause the processor to at least: identify a set of deal attributes in a deal data set that are indicative of past deals in a won category, wherein the deal data set includes deal data associated with past deals in the won category and past deals in a lost category; generate a random forest classifier based on the identified set of deal attributes and deal data of the past deals in the won category, wherein the random forest classifier includes a set of classifier trees configured to classify a deal based on at least a subset of deal attributes of the identified set of deal attributes; calculate a set of similarity factors based on the generated random forest classifier, wherein each similarity factor of the set of similarity factors indicates similarity between a deal in the won category of the deal data set and the current deal based on classifications of the set of classifier trees; determine at least one data value range of at least one performance indicator of past deals in the won category that are similar to the current deal based on the calculated set of similarity factors; and based on comparing the determined at least one data value range to at least one performance indicator data value of the current deal, provide action item information associated with the at least one performance indicator data value of the current deal.

Alternatively, or in addition to the other examples described herein, examples include any combination of the following:
wherein the at least one memory and the computer program code are configured to, with the at least one processor, further cause the processor to: identify a subset of past activities associated with the activity outcome that are similar to the current activity based on similarity factors associated with the subset of past activities exceeding a similarity threshold; and wherein determining at least one data value range of at least one performance indicator includes determining at least one data value range of at least one performance indicator of the identified subset of past activities.
wherein calculating the set of similarity factors includes calculating a similarity factor associated with the current activity and a past activity based on a percentage of classifier trees of the random forest classifier classifying the current activity and the past activity on a matching leaf node.
wherein identifying a set of attributes that are indicative of an activity outcome includes identifying, for an attribute of the set of attributes, a threshold value wherein a first ratio of past activities associated with the activity outcome have values associated with the attribute on a first side of the threshold value and a second ratio of past activities associated with an opposite activity outcome have values associated with the attribute on a second side of the threshold value.
wherein generating a random forest classifier based on the identified set of attributes includes generating a plurality of classifier trees, wherein each classifier tree includes a plurality of nodes configured to evaluate a plurality of attributes of the set of attributes, wherein the plurality of nodes in each classifier tree are arranged in a random order within the classifier tree.
wherein providing action item information associated with the at least one performance indicator data value of the current activity includes providing at least one of text information or information in a visualization for display to a user on a graphical user interface.
further comprising: identifying a subset of past deals in the won category that are similar to the current deal based on similarity factors associated with the subset of past deals exceeding a similarity threshold; and wherein determining at least one data value range of at least one performance indicator includes determining at least one data value range of at least one performance indicator of the identified subset of past deals.
wherein calculating the set of similarity factors includes calculating a similarity factor associated with the current deal and a past deal based on a percentage of classifier trees of the random forest classifier classifying the current deal and the past deal on a matching leaf node.
wherein identifying a set of deal attributes that are indicative of past deals in a won category includes identifying, for an attribute of the set of deal attributes, a threshold value wherein a first ratio of past deals in the won category have values associated with the attribute on a first side of the threshold value and a second ratio of past deals in the lost category have values associated with the attribute on a second side of the threshold value.
wherein each classifier tree of the set of classifier trees includes a plurality of nodes configured to evaluate a plurality of deal attributes of the set of deal attributes, wherein the plurality of nodes in each classifier tree are arranged in a random order within the classifier tree.
wherein providing action item information associated with the at least one performance indicator data value of the current deal includes providing at least one of text information or information in a visualization for display to a user on a graphical user interface.
wherein the identified set of deal attributes includes at least one of an age of the deal, a size of the deal, a location associated with the deal, a deal opening date, a deal closing date, a deal type or category, an owner of the deal, or a customer of the deal.
wherein the at least one performance indicator of past deals associated with the determined at least one data value range includes at least one of a customer interaction quantity, a customer interaction type, a quantity of time spent, a response rate to customer communications, or time to respond to customer communications.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for identifying a set of attributes in an activity data set that are indicative of an activity outcome; exemplary means for generating a random forest classifier based on the identified set of attributes, wherein the random forest classifier is configured to classify an activity based on the identified set of attributes; exemplary means for calculating a set of similarity factors associated with the current activity based on the generated random forest classifier, wherein each similarity factor of the set of similarity factors is associated with the current activity and a past activity associated with the activity; exemplary means for determining at least one data value range of at least one performance indicator of past activities associated with the activity outcome and similar to the current activity based on the set of similarity factors; and, based on comparing the determined at least one data value range to at least one performance indicator data value of the current activity, exemplary means for providing action item information associated with the at least one performance indicator data value of the current activity.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for providing action item information for a current activity based on similarity with past activities, the system comprising:
at least one processor of a management system; and
at least one memory of the management system comprising computer program code, the at least one memory and the computer program code configured to, with the at least one processor, cause the at least one processor to:
identify a set of attributes in an activity data set that are indicative of an activity outcome;
generate a random forest classifier based on the identified set of attributes, wherein the random forest classifier is configured to classify an activity based on the identified set of attributes;
calculate a set of similarity factors associated with the current activity based on the generated random forest classifier, wherein each similarity factor of the set of similarity factors is associated with the current activity and a past activity associated with the activity outcome in the activity data set;
determine at least one data value range of at least one performance indicator of past activities associated with the activity outcome and similar to the current activity based on the set of similarity factors; and
based on comparing the determined at least one data value range to at least one performance indicator data value of the current activity, provide action item information associated with the at least one performance indicator data value of the current activity.

2. The system of claim 1, wherein the at least one memory and the computer program code are configured to, with the at least one processor, further cause the processor to:
identify a subset of past activities associated with the activity outcome that are similar to the current activity based on similarity factors associated with the subset of past activities exceeding a similarity threshold; and
wherein determining at least one data value range of at least one performance indicator includes determining at least one data value range of at least one performance indicator of the identified subset of past activities.

3. The system of claim 1, wherein calculating the set of similarity factors includes calculating a similarity factor associated with the current activity and a past activity based on a percentage of classifier trees of the random forest classifier classifying the current activity and the past activity on a matching leaf node.

4. The system of claim 1, wherein identifying a set of attributes that are indicative of an activity outcome includes identifying, for an attribute of the set of attributes, a threshold value wherein a first ratio of past activities associated with the activity outcome have values associated with the attribute on a first side of the threshold value and a second ratio of past activities associated with an opposite activity outcome have values associated with the attribute on a second side of the threshold value.

5. The system of claim 1, wherein generating a random forest classifier based on the identified set of attributes includes generating a plurality of classifier trees, wherein each classifier tree includes a plurality of nodes configured to evaluate a plurality of attributes of the set of attributes, wherein the plurality of nodes in each classifier tree are arranged in a random order within the classifier tree.

6. The system of claim 1, wherein providing action item information associated with the at least one performance indicator data value of the current activity includes providing at least one of text information or information in a visualization for display to a user on a graphical user interface.

7. A computerized method for providing action item information for a current deal based on similarity with past deals in a customer relationship management system, the computerized method comprising:
identifying, by a processor, a set of deal attributes in a deal data set that are indicative of past deals in a won category, wherein the deal data set includes deal data associated with past deals in the won category and past deals in a lost category;
generating, by the processor, a random forest classifier based on the identified set of deal attributes and deal data of the past deals in the won category, wherein the random forest classifier includes a set of classifier trees configured to classify a deal based on at least a subset of deal attributes of the identified set of deal attributes;
calculating, by the processor, a set of similarity factors based on the generated random forest classifier, wherein each similarity factor of the set of similarity factors indicates similarity between a deal in the won category of the deal data set and the current deal based on classifications of the set of classifier trees;
determining, by the processor, at least one data value range of at least one performance indicator of past deals in the won category that are similar to the current deal based on the calculated set of similarity factors; and
based on comparing the determined at least one data value range to at least one performance indicator data value of the current deal, providing, by the processor, action item information associated with the at least one performance indicator data value of the current deal.

8. The computerized method of claim 7, the computerized method further comprising:
identifying a subset of past deals in the won category that are similar to the current deal based on similarity factors associated with the subset of past deals exceeding a similarity threshold; and
wherein determining at least one data value range of at least one performance indicator includes determining at least one data value range of at least one performance indicator of the identified subset of past deals.

9. The computerized method of claim 7, wherein calculating the set of similarity factors includes calculating a similarity factor associated with the current deal and a past deal based on a percentage of classifier trees of the random forest classifier classifying the current deal and the past deal on a matching leaf node.

10. The computerized method of claim 7, wherein identifying a set of deal attributes that are indicative of past deals in a won category includes identifying, for an attribute of the set of deal attributes, a threshold value wherein a first ratio of past deals in the won category have values associated with the attribute on a first side of the threshold value and a second ratio of past deals in the lost category have values associated with the attribute on a second side of the threshold value.

11. The computerized method of claim 7, wherein each classifier tree of the set of classifier trees includes a plurality of nodes configured to evaluate a plurality of deal attributes of the set of deal attributes, wherein the plurality of nodes in each classifier tree are arranged in a random order within the classifier tree.

12. The computerized method of claim 7, wherein providing action item information associated with the at least one performance indicator data value of the current deal includes providing at least one of text information or information in a visualization for display to a user on a graphical user interface.

13. The computerized method of claim 7, wherein the identified set of deal attributes includes at least one of an age of the deal, a size of the deal, a location associated with the deal, a deal opening date, a deal closing date, a deal type or category, an owner of the deal, or a customer of the deal.

14. The computerized method of claim 7, wherein the at least one performance indicator of past deals associated with the determined at least one data value range includes at least one of a customer interaction quantity, a customer interaction type, a quantity of time spent, a response rate to customer communications, or time to respond to customer communications.

15. One or more computer storage media having computer-executable instructions for providing action item information for a current deal based on similarity with past deals in a customer relationship management system that, upon execution by a processor, cause the processor to at least:
identify a set of deal attributes in a deal data set that are indicative of past deals in a won category, wherein the deal data set includes deal data associated with past deals in the won category and past deals in a lost category;
generate a random forest classifier based on the identified set of deal attributes and deal data of the past deals in the won category, wherein the random forest classifier includes a set of classifier trees configured to classify a deal based on at least a subset of deal attributes of the identified set of deal attributes;
calculate a set of similarity factors based on the generated random forest classifier, wherein each similarity factor of the set of similarity factors indicates similarity between a deal in the won category of the deal data set and the current deal based on classifications of the set of classifier trees;
determine at least one data value range of at least one performance indicator of past deals in the won category that are similar to the current deal based on the calculated set of similarity factors; and
based on comparing the determined at least one data value range to at least one performance indicator data value of the current deal, provide action item information associated with the at least one performance indicator data value of the current deal.

16. The one or more computer storage media of claim 15, wherein the computer-executable instructions, upon execution by a processor, further cause the processor to at least:
identify a subset of past deals in the won category that are similar to the current deal based on similarity factors associated with the subset of past deals exceeding a similarity threshold; and
wherein determining at least one data value range of at least one performance indicator includes determining at least one data value range of at least one performance indicator of the identified subset of past deals.

17. The one or more computer storage media of claim 15, wherein calculating the set of similarity factors includes calculating a similarity factor associated with the current deal and a past deal based on a percentage of classifier trees of the random forest classifier classifying the current deal and the past deal on a matching leaf node.

18. The one or more computer storage media of claim 15, wherein identifying a set of deal attributes that are indicative of past deals in a won category includes identifying, for an attribute of the set of deal attributes, a threshold value wherein a first ratio of past deals in the won category have values associated with the attribute on a first side of the threshold value and a second ratio of past deals in the lost category have values associated with the attribute on a second side of the threshold value.

19. The one or more computer storage media of claim 15, wherein each classifier tree of the set of classifier trees includes a plurality of nodes configured to evaluate a plurality of deal attributes of the set of deal attributes, wherein the plurality of nodes in each classifier tree are arranged in a random order within the classifier tree.

20. The one or more computer storage media of claim 15, wherein providing action item information associated with the at least one performance indicator data value of the current deal includes providing at least one of text information or information in a visualization for display to a user on a graphical user interface.
